(19) United States
(12) Patent Application Publication
(10) Pub. No.: US 2005/0247913 A1
(43) Pub. Date: Nov. 10, 2005

(54) Phosphorous ester compound, process for producing the same, and use thereof

(76) Inventors: Mutsuko Higo, Toyonaka-shi (JP); Masaaki Tanaka, Toyonaka-shi (JP); Hideaki Awa, Ibaraki-shi (JP)

Correspondence Address: SUGHRUE MION, PLLC, 2100 PENNSYLVANIA AVENUE, N.W., SUITE 800, WASHINGTON, DC, 20037, US

(21) Appl. No.: 10/525,523

(22) PCT Filed: Aug. 25, 2003
(86) PCT No.: PCT/JP03/10680

§ 371 Date: Feb. 24, 2005

(30) Foreign Application Priority Data
Aug. 30, 2002 (JP) 2002-253210

(51) Int. Cl. C09K 15/32

(52) U.S. Cl. 252/400.24

(57) ABSTRACT

A phosphorous ester compound of formula (I): 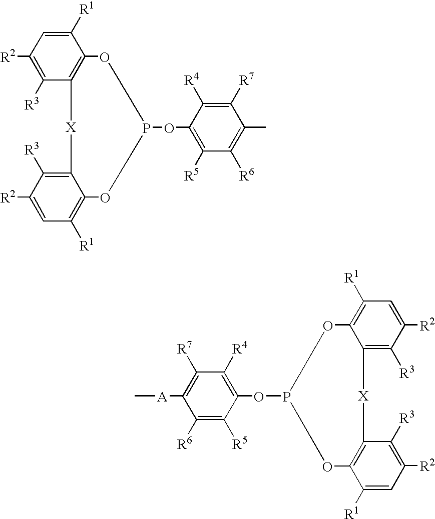
wherein R¹ and R² independently represent hydrogen, C₁₋₈ alkyl, C₅₋₈ cycloalkyl, C₆₋₁₂ alkylcycloalkyl, C₇₋₁₂ aralkyl or phenyl,
R³ represents hydrogen or C₁₋₈ alkyl,
R⁴, R⁵, R⁶ and R⁷ independently represent hydrogen, C₁₋₈ alkyl, C₅₋₈ cycloalkyl, C₆₋₁₂ alkylcycloalkyl, C₇₋₁₂ aralkyl, phenyl, C₁₋₈ alkoxy, or halogen,
provided that four R¹ groups are the same or different, four R² groups are the same or different, two R⁴ groups are the same or different, two R⁵ groups are the same or different, two R⁶ groups are the same or different, and two R⁷ groups are the same or different,
X represents a single bond, sulfur, or —CHR⁸—, wherein R⁸ represents hydrogen, C₁₋₈ alkyl, or C₅₋₈ cycloalkyl, A represents a single bond, oxygen, etc.

### TECHNICAL FIELD OF THE INVENTION

The present invention relates to a phosphorous ester compound, a process for producing the same, and use thereof as a stabilizer for organic materials.

### BACKGROUND ART

It has been known that commercial values of organic materials such as thermoplastic resins, thermosetting resins, natural or synthetic rubbers, mineral oils, lubricating oils, adhesives or paints are remarkably deteriorated during their production, processing or use because of the loss of strength properties, change of fluidity, coloring, worsening of surface properties resulting from those phenomenon such as fission or cross-linking of molecules through the action of heat or oxygen. It has been known that the organic material were stabilized by adding phosphorous type anti-oxidizers to solve the problems of heat- or oxidation-deterioration.

As the phosphorous type anti-oxidizers, there was proposed, for example, a cyclic phosphorous ester compound composed of a substituted aryl group and a single cyclic phosphorous ester group that are connected through a divalent group such as a carbonyl group or an alkylene group (see JP10-273494A). The cyclic phosphorous ester compound described in JP10-273494A, however, has a problem in that it was difficult to obtain an organic material with stable quality due to the facts that the ester is readily hydrolyzable and processing stability of the organic material was not secured by hydrolysis during storage. In addition, the cyclic phosphorous ester has still another problem in that metal materials of the instrument used to the processing of the organic materials was corroded by the phosphorous acid resulting from the hydrolysis of the ester.

### DISCLOSURE OF THE INVENTION

The present invention is to provide a stabilizer that is resistant to hydrolysis and is excellent in stabilizing effect and in improving thermo-resistance when used as a stabilizer for organic materials.

The present invention provides:
1. a phosphorous ester compound of formula (I): 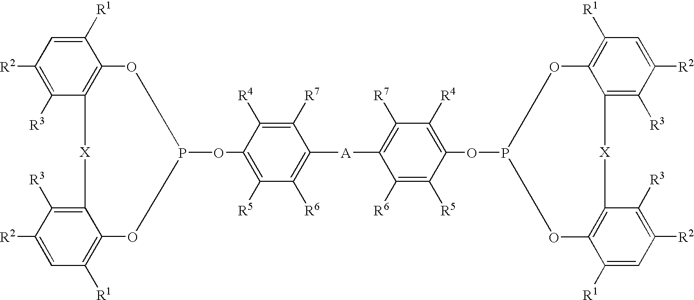
   wherein R¹ and R² independently represent hydrogen, C₁₋₈ alkyl, C₅₋₈ cycloalkyl, C₆₋₁₂ alkylcycloalkyl, C₇₋₁₂ aralkyl or phenyl,
R³ represents hydrogen or C₁₋₈ alkyl,
R⁴, R⁵, R⁶ and R⁷ independently represent hydrogen, C₁₋₈ alkyl, C₅₋₈ cycloalkyl, C₆₋₁₂ alkylcycloalkyl, C₇₋₁₂ aralkyl, phenyl, C₁₋₈ alkoxy, or halogen,
provided that four R¹ groups are the same or different, four R² groups are the same or different, two R⁴ groups are the same or different, two R⁵ groups are the same or different, two R⁶ groups are the same or different, and two R⁷ groups are the same or different,
X represents a single bond, sulfur, or —CHR⁸—, wherein R⁸ represents hydrogen, C₁₋₈ alkyl, or C₅₋₈ cycloalkyl,
A represents
a single bond, oxygen, sulfur, sulfonyl, sulfinyl, carbonyl, phenylene, a group of formula (IV):
   —C(R⁹)(R¹⁰)— (IV)
   wherein R⁹ and R¹⁰ independently represent hydrogen, phenyl, C₁₋₈ alkyl, C₅₋₈ cycloalkyl, or C₅₋₈ alkylcycloalkyl, or
a divalent bicyclic saturated hydrocarbon group, or
a divalent hydrocarbon group of formula (V): 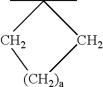
   wherein a represents an integer of 2 to 5, the alkylene group may be substituted with C₁₋₈ alkyl group, or may form a fused ring with one or two benzene rings;
2. a process for producing the phosphorous ester (I) compound as defined above, which comprises reacting a diphenol compound of formula (II): 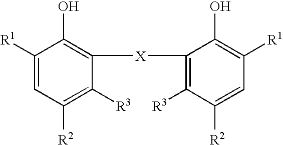
   wherein R¹, R², R³ and X are as defined above,
phosphorous trichloride, and a bisphenol compound of formula (III): 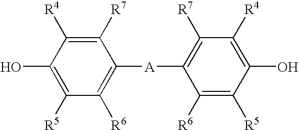
   wherein R⁴, R⁵, R⁶, R⁷ and A are as defined above; and
3. a stabilizer for organic material, comprising, as effective ingredient, the phosphorous ester compound (I) as defined above.

### MODE FOR CARRYING OUT THE INVENTION

The R¹ and R² groups in the phosphorous ester compound (I) will be explained below.

Examples of the C₁₋₈ alkyl group represented by R¹ and R² include, for example, methyl, ethyl, n-propyl, iso-propyl, n-butyl, isobutyl, sec-butyl, t-butyl, t-pentyl, iso-octyl, t-octyl, 2-ethylhexyl and the like.

Examples of the C₅₋₈ cycloalkyl above include, for example, cyclopentyl, cyclohexyl, cycloheptyl, cyclooctyl and the like.

Examples of the C₆₋₁₂ alkylcycloalkyl above include, for example, 1-methylcyclopentyl, 1-methylcyclohexyl, 1-methyl-4-iso-propylcyclohexyl and the like.

Examples of the C₇₋₁₂ aralkyl group above include, for example, benzyl, α-methylbenzyl, α, α-dimethylbenzyl, 1-naphthylmethyl, 2-naphthylmethyl, 1-naphthylethyl, 2-naphthylethyl and the like.

Preferred R¹ is t-alkyl (tertiary alkyl) group such as t-butyl, t-pentyl, t-octyl or the like, or substituted or unsubstituted cyclohexyl such as cyclohexyl, 1-methylcyclohexyl or the like.

Preferred R² is C₁₋₅ alkyl such as methyl, ethyl, n-propyl, iso-propyl, n-butyl, iso-butyl, sec-butyl, t-butyl, t-pentyl or the like, and particularly preferred are methyl, t-butyl, and t-pentyl.

Examples of the C₁₋₈ alkyl group represented by R³ include, for example, the same groups as exemplified for R¹ and R². Preferred R³ is hydrogen or C₁₋₅ alkyl, and particularly preferred is hydrogen or methyl.

Examples of the C₁₋₈ alkyl, C₅₋₈ cycloalkyl, C₆₋₁₂ alkylcycloalkyl, and C₇₋₁₂ aralkyl groups represented by R⁴, R⁵, R⁶ and R⁷ include, for example, the same alkyl, cycloalkyl, alkylcycloalkyl and aralkyl groups as exemplified for R¹ and R² above.

Examples of the C₁₋₈ alkoxy group represented by R₄, R₅, R₆ and R₇ include, for example, methoxy, ethoxy, n-propoxy, iso-propoxy, n-butoxy, iso-butoxy, sec-butoxy, t-butoxy, t-pentyloxy, n-hexyloxy, n-heptyloxy, octyloxy and the like.

Preferred R₄, R₅, R₆ and R₇ groups are hydrogen or C₁₋₅ alkyl.

Examples of the C₁₋₈ alkyl and C₅₋₈ cycloalkyl groups represented by R⁸, when X is —CHR⁸—, include, for example, the same alkyl and cycloalkyl groups exemplified for R¹ and R² above.

X is preferably a single bond, unsubstituted methylene, substituted methylene, which is substituted with a C1-4 alkyl group such as methyl, ethyl, n-propyl, iso-propyl, n-butyl, iso-butyl, t-butyl or the like.

Examples of the C₁₋₈ alkyl, and C₅₋₈ cycloalkyl represented by R⁹ and R¹⁰ above, when A represents a group of formula (IV), include, for example, the same alkyl, cycloalkyl and alkylcycloalkyl and the like as exemplified for R¹ and R² above, and examples of the C₅₋₈ alkylcycloalkyl include, for example, 1-methylcyclobutyl, 1-methylcyclopentyl, 1-methylcyclohexy, 1-methyl-4-iso-propylcyclohexyl and the like.

Examples of the group of formula (VI) include, for example, methylene, and methylene substituted with the C₁₋₈ alkyl group as described above such as methylidene, ethylidene, isopropylidene, propylidene, butylidene, 1-pentylidene, 3-pentylidene, hexylidene, heptylidene, octylidene, nonylidene, benzylidene or the like.

Examples of the divalent cyclic hydrocarbon group of formula (V), represented by A, include, for example, cyclopentylidene, cyclohexylidene, methylcyclohexylidene, cycloheptylidene, cyclooctylidene, fluorenyliden, and indanylidene.

Examples of the divalent bicyclic saturated hydrocarbon residue represented by A include, for example, C₁₀ bicyclic saturated hydrocarbon residue such as divalent bornylene residue(e.g., 2,3-bornylene) or the like.

Preferably A is a single bond, oxygen, sulfur, sulfonyl, sulfinyl, carbonyl, phenylene, or isopropylidene.

The phosphorous ester compound (I) can be produced, for example, by reacting the diphenol compound of formula (II), phosphorous trihalide, and bisphenol compound of formula (III).

Examples of the phosphrous trihalide include, for example, phosphorous trichloride, phosphorous tribromide and the like. Particularly preferably used is phosphorous trichloride.

The reaction of the diphenol compound (II), phosphorous trihalide, and the bisphenol compound (III) can also be accelerated in the co-presence of dehydrohalogenating agent such as amine compounds, pyridine compounds, pyrrolidine compounds, amide compounds, etc., or hydroxides of alkali metals or alkaline earth metals.

The amines may be a primary amine, a secondary amine or a tertiary amine, and examples thereof include t-butylamine, t-pentylamine, t-hexylamine, t-octylamine, di-t-butylamine, di-t-pentylamine, di-t-hexylamine, di-t-octylamine, trimethylamine, triethylamine, N,N-dimethylaniline, N,N-diethylaniline and the like, and preferred is triethylamine.

The pyridine compounds include pyridine, and picoline, and preferred is pyridine. The pyrrolidine compounds include, for example, 1-methyl-2-pyrrolidine.

The amide compounds include, for example, N,N-dimethylformamide, and N,N-dimethylacetamide, and preferred is N,N-dimethylformamide.

Examples of the hydroxides of alkali metals or alkali earth metals include, for example, sodium hydroxide, calcium hydroxide and the like, and preferred is sodium hydroxide.

The reaction of the diphenol compound (II), the phosphrous trihalide and the bisphenol compound (III) is preferably carried out in an inert organic solvent. The inert organic solvent is not specifically limited unless the reaction is not inhibited, and examples thereof include aromatic hydrocarbon, aliphatic hydrocarbon, ether solvents, halogenated hydrocarbon, and the like.

Examples of the aromatic hydrocarbon include, for example, benzene, toluene, xylene, ethylbenzene, and the like. Examples of the aliphatic hydrocarbon include, for example, n-hexane, n-heptane, n-octane, and the like. Examples of the ether solvents include, for example, diethyl ether, dibutyl ether, tetrahydrofuran, 1,4-dioxane, and the like. Examples of the halogenated hydrocarbon include, for example, chloroform, carbon tetrachloride, monochlorobenzene, dichloromethane, 1,2-dichloroethane, dichlorobenzene, and the like.

Among the organic solvents, toluene, xylene, n-hexane, n-heptane, diethylether, tetrahydrofuran, 1,4-dioxane, chloroform, dichloromethane and the like are preferably used.

As the reaction method, preferably used is a two step method comprising reacting a the dipheol compound of formula (II) with phosphorous trihalide and then reacting the resulting intermediate product with the bisphenol compound compound (III).

In the two step method, phosphorous trihalide is preferably used in an amount of about 1 to 1.1 moles, more preferably 1 to 1.05 moles per mol of the diphenol compound (II).

When the dehydrohalogenating agent such as theamine, pyridine compounds, pyrrolidine compounds or amide compounds is used, it is preferably used in an amount of about 0.05 to 2.4 moles, more preferably about 2 to 2.1 moles, per mol of the phosphorous trihalide above.

The reaction of the diphenol compound (II) and phosphorous trihalide is preferably conducted at about 0 to 200° C. The intermediate product (halogeno-phosphite) can be isolated and furnished to the next reaction but it is preferably furnished to the reaction with the bisphenol compound (III) in a form of the reaction mixture.

The bisphenol compound (III) is preferably used in the amount of about 0.5 to 0.6 mol per mol of the diphenol compound (II) used in the reaction of diphenol compound (II) and phosphorous trihalide. In this reaction a dehydrohalogenating agent can be used, and the amount thereof when used is preferably about 0.05 to 1.2 moles per mol of the bisphenol compound (III). The amount of the dehydrohalogenating agents can be calculated by incorporating the amount of the remaining dehydrohalogenating agent, which was used in excess in the prior reaction.

After the completion of the reaction, when a dehydrohalogenating agent is used, the phosphorous ester compound (I) of the present invention can be isolated by removing a product (hydrogen halide) resulting from the dehydrohalogenating agent, and removing the solvent, and subjecting the resultant to a suitable post-treatment such as a crystallization, column chromatography, or the like.

The diphenol compound (II), which is the starting material of the phosphorous ester compound (I), can be produced by condensing alkylphenol compounds in a similar manner as disclosed in JP52-122350A, U.S. Pat. No. 2,538,355, JP2-47451B and the like. As the bisphenol compound (II), commercially available compounds may be used.

Examples of the bisphenol (II) include, for example,
2,2′-methylenebis(4-methyl-6-t-butylphenol),
2,2′-methylenebis(4-ethyl-6-t-butylphenol),
2,2′-methylenebis(4-n-propyl-6-t-butylphnenol),
2,2′-methylenebis(4-i-prouyl-6-t-butylphenol),
2,2′-methylenebis-(4-n-butyl-6-t-butylphenol,
2,2′-methylenebis(4-i-butyl-6-t-butylphenol),
2,2′-methylenebis(4,6-di-t-butylphenol),
2,2′-methylenebis(4-t-pentyl-6-t-butylphenol),
2,2′-methylenebis(4-nonyl-6-t-butylphenol),
2,2′-methylenebis(4-t-octyl-6-t-butylphenol),
2,21′-methylenebis(4-methyl-6-t-pentylphenol),
2,2′-methylenebis(4-methyl-6-cyclohexylphenol)
2,21′-methylenebis[4-methyl-6-(α-methylcyclohexyl)phenol)],
2,2′-methylenebis(4-methyl-6-t-nonylphenol),
2,2′-methylenebis(4-methyl-6-t-octylphenol),
2,2′-methylenebis(4,6-di-t-pentylphenol),
2,2′-methylenebis[4-nonyl-6-(α-methylbenzyl)phenol],
2,2′-methylenebis[4-nonyl-6-(α,α-dimethylbenzyl)phenol],
2,2′-ethylidenebis(4-methyl-6-butylphenol),
2,2′-ethylidenebis(4-ethyl-6-t-butylphenol),
2,2′-ethylidenebis(4-n-propyl-6-t-butylphenol),
2,2′-ethylidenebis(4-i-propyl-6-t-butylphenol),
2,2′-ethylidenebis(4-n-butyl-6-t-butylphenol),
2,2′-ethylidenebis(4-i-butyl-6-t-butylphenol),
2,2′-ethylidenebis(4,6-di-t-butylphenol),
2,2′-ethylidenebis(4-t-pentyl-6-t-butylphenol),
2,2′-ethylidenebis(4-nonyl-6-t-butylphenol),
2,2′-ethylidenebis(4-t-octyl-6-t-butylphenol),
2,2′-ethylidenebis(4-methyl-6-t-pentylphenol),
2,2′-ethylidenebis(4-methyl-6-cyclohexylphenol),
2,2′-ethylidenebis[4-methyl-6-(α-methylcyclohexyl)phenol)],
2,2′-ethylidenebis(4-methyl-6-nonylphenol),
2,2′-ethylidenebis(4-methyl-6-t-octylphenol),
2,2′-ethylidenebis(4,6-di-t-pentylphenol),
2,2′-ethylidenebis[4-nonyl-6-(α-methylbenzyl)phenol],
2,2′-ethylidenebis[4-nonyl-6-(α,α-dimethylbenzyl)phenol],
2,2′-propylidenebis(4-methyl-6-t-butylphenol),
2,2′-propylidenebis(4-ethyl-6-t-butylphenol),
2,2′-propylidenebis(4-n-propyl-6-t-butylphenol),
2,2′-propylidenebis(4-i-propyl-6-t-butylphenol),
2,2′-propylidenebis(4-n-butyl-6-t-butylphenol),
2,2′-propylidenebis(4-i-butyl-6-t-butylphenol),
2,2′-propylidenebis(4,6-di-t-butylphenol),
2,2′-propylidenebis(4-t-pentyl-6-t-butylphenol),
2,2′-propylidenebis(4-nonyl-6-t-butylphenol),
2,2′-propylidenebis(4-t-octyl-6-t-butylphenol),
2,2′-propylidenebis(4-methyl-6-t-pentylphenol),
2,2′-propylidenebis(4-methyl-6-cyclohexylphenol),
2,2′-propylidenebis[4-methyl-6-(α-methylcyclohexyl)phenol],
2,2′-propylidenebis(4-methyl-6-nonylphenol),
2,2′-propylidenebis(4-methyl-6-t-octylphenol),
2,2′-propylidenebis(4,6-di-t-pentylphenol),
2,2′-propylidenebis[4-nonyl-6-(α-methylbenzyl)phenol],
2,2′-propylidenebis[4-nonyl-6-(α,α-dimethylbenzyl)phenol],
2,2′-butylidenebis(4-methyl-6-t-butylphenol),
2,2′-butylidenebis(4-ethyl-6-t-butylphenol),
2,2′-butylidenebis(4,6-di-t-butylphenol),
2,2′-butylidenebis(4-methyl-6-cyclohexylphenol),
2,2′-butylidenebis[4-methyl-6-(α-methylcyclohexyl)phenol],
2,2′-butylidenebis(4,6-di-t-pentylphenol),
2,2′-i-butylidenebis(4-methyl-6-t-butylphenol),
2,2′-i-butylidenebis(4-ethyl-6-t-butylphenol),
2,2′-i-butylidenebis(4,6-di-t-butylphenol),
2,2′-i-butylidenebis(4-methyl-6-cyclohexylphenol),
2,2′-i-butylidenebis[4-methyl-6-(α-methylcyclohexyl)phenol],
2,2′-i-butylidenebis(4,6-di-t-pentylphenol),
2,2′-i-pentylidenebis(4-methyl-6-t-butylphenol),
2,2′-i-pentylidenebis(4-ethyl-6-t-butylphenol),
2,2′-i-pentylidenebis(4,6-di-t-butylphenol),
2,2′-i-pentylidenebis(4-methyl-6-cyclohexylphenol),
2,2′-pentylidenebis[4-methyl-6-(α-methylcyclohexy)-phenol], 2,2′-pentylidenebis(4,6-di-t-pentylphenol), biphenyl-2,2′-diol,
3,3′, 5,5′-tetra-t-butylbiphenyl-2,2′-diol and
1,1′-binaphthyl-2,2′-diol.

The biphenol compound (III) an be produced by a known manner and commercially available bisphenol compound (III) can be used.

Examples of the bisphenol compound (III) include, for example, 4,4′-bisphenol, 4,4′-dihydroxydiphenyl ether,
Bis(4-hydroxydiphenyl) sulfide,
4,4′-dihydroxy-3,3′-dichlorodiphenyl ether,
4,4′-dihydroxy-2,5-diethoxydiphenyl ether,
bis(4-hydroxyphenyl)sulfone,
4,4′dihydroxybenzophenone, 2,2-bis(4-hydroxypheny)propane,
2,2-bis(4-hydroxy-3,5-dimethylphenyl)propane,
2,2-bis(4-hydroxy-3,5-diethylphenyl)propane,
2,2-bis(4-hydroxy(3,5-phenyl)phenyl)propane,
2,2-bis(4-hydroxy-3,5-dibromophenyl)propane,
2,2-bis(4-hydroxyphenyl)pentane,
bis(4-hydroxypheny)methane,
1,1-bis-(4-hydroxyphenyl)ethane,
3,3-bis-(4-hydroxyphenyl)pentane,
1,1-bis-(4-hydroxyphenyl)cyclohexane and the like.

Examples of the phosphorous ester compound (I) of the present invention thus obtained include, for example, following compounds of formula (I), wherein R³ to R⁷ represent hydrogen atom, and R¹, R², X and A represent the following groups.

TABLE I

| No. | R¹ | R² | X | A |
|---|---|---|---|---|
| 1 | t-Bu | t-Bu | single bond | O |
| 2 | t-Bu | t-Bu | single bond | S |
| 3 | t-Bu | t-Bu | single bond | S(O)₂ |
| 4 | t-Bu | t-Bu | single bond | single bond |
| 5 | t-Bu | t-Bu | single bond | C(CH₃)₂ |
| 6 | t-Bu | Me | CH₂ | O |
| 7 | t-Bu | Me | CH₂ | S |
| 8 | t-Bu | Me | CH₂ | S(O)₂ |
| 9 | t-Bu | Me | CH₂ | single bond |
| 10 | t-Bu | Me | CH₂ | C(CH₃)₂ |
| 11 | t-Bu | t-Bu | CH₂ | O |
| 12 | t-Bu | t-Bu | CH₂ | S |
| 13 | t-Bu | t-Bu | CH₂ | S(O)₂ |
| 14 | t-Bu | t-Bu | CH₂ | single bond |
| 15 | t-Bu | t-Bu | CH₂ | C(CH₃)₂ |
| 16 | t-Am | t-Am | CH(CH₃) | O |
| 17 | t-Am | t-Am | CH(CH₃) | S |
| 18 | t-Am | t-Am | CH(CH₃) | S(O)₂ |
| 19 | t-Am | t-Am | CH(CH₃) | single bond |
| 20 | t-Am | t-Am | CH(CH₃) | C(CH₃)₂ |
| 21 | t-Bu | Et | CH₂ | O |
| 22 | t-Bu | Et | CH₂ | S |
| 23 | t-Bu | Et | CH₂ | S(O)₂ |
| 24 | t-Bu | Et | CH₂ | single bond |
| 25 | t-Bu | Et | CH₂ | C(CH₃)₂ |

In Table I, Me is methyl, Et is ethyl, t-Bu is tertiary butyl, and t-Am is tertiary amyl.

The hydrolysis resistance of the phosphorous ester comound (I) of the present invention can be improved by containing amines, acid-binding metal salts (double salt compounds such as hydrotalcites described below) and the like.

Typical examples of the amines include trialkanolamines such as triethanolamine, tripropanolamine, tri-i-propanolamine and the like;
dialkanolamines such as diethanolamine, dipropanolamine, di-i-propanolamine, tetraethanolethylenediamine, tetra-i-propanolethylenediamine and the like;
monoalkanolamines such as dibutylethanolamine, dibutyl-i-propanolamine and the like; aromatic amines such as 1,3,5-trimethyl-2,4,6-triazine and the like;
alkylamines such as dibutylamine, piperidine, 2,2,6,6,-tetramethylpiperidine,
4-hydroxy-2,2,6,6-tetramethylpiperidine and the like;
polyalkylenepolyamines such as hexamethylenetetramine, triethylenediamine, triethylenetetramine, tetraethylenepentamine and the like; and
hindered amine photostabilizers described below.

Furthermore, there can also be used a long-chain aliphatic amine described in JP61-63686A, a compound having a sterically hindered amine group described in JP6-329830A, a hindered piperidinyl photostabilizer described in JP7-90270A and an organic amine described in JP7-278164A.

The amount of the amines described above is preferably about 1 to 25 parts by weight per 100 parts by weight of the phosphorous ester compound (I).

Typical examples of the acid-binding metal salt include double salt compounds represented by the following formula:
M²⁺₁₋ₓ.M³⁺ₓ.(OH⁻)₂.(Aⁿ⁻) x/n.pH₂O
wherein M²⁺ represents Mg, Ca, Sr, Ba, Zn, Pb, Sn or Ni; M³⁺ represents Al, B or Bi; n represents an integer of 1 to 4; x represents a numerical value of 0 to 0.5; p represents an numerical value of 0 to 2; and Aⁿ⁻ represents an anion having a valency of n.

Specific examples of the anion having a valence of n represented by Aⁿ⁻ include OH⁻, Cl⁻, Br⁻, I⁻, ClO₄⁻, HCO₃⁻, C₆H₅COO⁻, CO₃²⁻, SO₂⁻, ⁻OOCCOO⁻,
(CHOHCOO)₂²⁻, C₂H₄(COO)₂²⁻, (CH₂COO)₂²⁻, CH₃CHOHCOO⁻, SiO₃²⁻, SiO₄⁴⁻, Fe(CN)₆⁴⁻, BO₃⁻, PO₃³⁻, HPO₄²⁻ and the like.

Particularly preferred one among them represented by the above formula include, for example, hydrotalcites represented by the following formula:
Mg₁₋ₓAlₓ (OH)₂(CO₃)_{x/2}.pH₂O
wherein x and p are as defined above.

The hydrotalcites may be natural or synthetic products, and can be used regardless of crystal structure and crystal particle diameter thereof.

Furthermore, an ultrafine zinc oxide described in JP6-329830A and an inorganic compound described in JP7-278164A can also be used.

The amount ratio of the acid-binding metal salts to the phosphorous ester compound (I) is usually about 0.01 to 25 wt%.

The phosphorous ester compound (I) of the present invention are effective for stabilizing the organic material against heat deterioration and oxidization deterioration.

Examples of the organic material that can be stabilized according to the present invention include the following:
(1) polyethylene such as high-density polyethylene (HD-PE), low-density polyethylene (LD-PE) or linear low-density polyethylene (LLDPE)
(2) polypropylene
(3) methylpentene polymer
(4) EEA (ethylene/ethyl acrylate copolymer) resin
(5) ethylene/vinyl acetate copolymer resin
(6) polystyrenes such as polystyrene, poly(p-methylstyrene) or poly(α-methylstyrene)
(7) AS (acrylonitrile/styrene copolymer) resin
(8) ABS (acrylonitrile/butadiene/styrene copolymer) resin
(9) AAS (special acrylic rubber/acrylonitrile/stvrene copolymer) resin
(10) ACS (acrylonitrile/chlorinated polyethylene/styrene copolymer) resin
(11) chlorinated polyethylene, polychloroprene, chlorinated rubber
(12) polyvinyl chloride, polyvinylidene chloride
(13) methacrylic resin
(14) etyhylene/vinyl alcohol copolymer resin
(15) fluororesin
(16) polyacetal
(17) grafted polyphenylene ether resin and polyphenylene sulfide resin
(18) polyurethane
(19) polyamide
(20) polyester resin such as polyethylene terephthalate or polybutylene terephthalate
(21) polycarbonate
(22) polyacrylate
(23) polysulfone, polyether ether ketone, polyether sulfone
(24) thermoplastic resin such as aromatic polyester resin, etc.
(25) epoxy resin
(26) diallyl phthalate prepolymer
(27) silicone resin
(28) unsaturated polyester resin
(29) acrylic-modified benzoguanamine resin
(30) benzoguanamine/melamine resin
(31) thermosetting resin such as urea resin, etc.
(32) polybutadiene
(33) 1,2-polybutadiene
(34) polyisoprene
(35) styrene/butadiene copolymer
(36) butadiene/acrylonitrile copolymer
(37) ethylene/propylene copolymer
(38) silicone rubber
(39) epichlorohydrin rubber
(40) acrylic rubber
(41) natural rubber
(42) chlorinated rubber paint
(43) polyester resin paint
(44) urethane resin paint
(45) epoxy resin paint
(46) acrylic resin paint
(47) vinyl resin paint
(48) aminoalkyd resin paint
(49) alkyd resin
(50) nitrocellulose resin paint
(51) oil-based paint
(52) wax, and
(53) lubricating oil.

The organic materials can be stabilized alone or in combination thereof. The organic materials which can be stabilized are not limited to the organic materials exemplified above. Among them, preferably used are the thermoplastic resin, particularly polyolefin such as polyethylene (e.g. HD-PE, LD-PE, LLDPE, etc.) and polyolefin (e.g. polypropylene, etc.), and the engineering resins such as polyamide, polyethylene terephthalate, polybutylene terephthalate, polycarbonate, liquid-crystal polyester, polyether sulfone, polysulfone, polyether ketone.

The polyolefin are not specifically limited. For example, they may be those obtained by the radical polymerization or those produced by the polymerization using a catalyst containing a metal of Group 4, 5, 6, 8, 9 or 10 of the Pperiodic Table of Element. The catalyst containing such a metal may be a metal complex containing one or more coordinated ligands such as oxide which is coordinated by a τ- or σ-bond, halogenated compound, alcoholate, ester, aryl or the like, and these complexes may be used as it is, or in a supported form on a base material such as magnesium chloride, titanium chloride, alumina, silicon oxide, or the like.

As the polyolefin, for example, there are preferably used those produced by using Ziegler-Natta catalyst, TNZ catalyst, metallocene catalyst, Phillips catalyst and the like.

Also the engineering resin is not specifically limited. The polyamide resin may be those which have an amide bond at the polymer chain and can be molten with heating. For example, they may be produced by any method such as condensation reaction between diamines and dicarboxylic acids, condensation reaction of aminocarboxylic acids and ring opening polymerization of lactams. Typical examples thereof include nylon 66, nylon 69, nylon 610, nylon 612, poly-bis(p-aminocyclohexyl)methanedodecamide, nylon 46, nylon 6, nylon 12 and copolymers (e.g. nylon 66/6 as a copolymer of nylon 66 and nylon 6, nylon 6/12, or the like).

The polyester resin may be those which have an ester bond at the polymer chain and can be molten with heating. Examples thereof include polyester obtained by the polycondensation between dicarboxylic acids and a dihydroxy compound. The polyester may be a homopolyester or a copolyester.

The polycarbonate may be those which have a carbonate bond at the polymer chain and can be molten with heating. Examples thereof include, for example, polycarbonate obtained by reacting an aromatic hydroxy compound and optionally with a small amount of polyhydroxy compound with a carbonate precursor such as phosgene, diphenyl carbonate, etc. in the presence of a solvent, an acid receptor and a molecular weight adjustor, The polycarbonate resin may be straight-chain or branched resin, or may be a copolymer.

When the phosphrous ester compound (I) is incorporated to stabilize the organic material, the phosphrous ester compound (I) is preferably incorporated in an amount of about 0.001 to 5 parts by weight, more preferably about 0.005 to 3 parts by weight, still more preferably about 0.01 to 1 part by weight per 100 parts by weight of the organic material.

When the phosphorous ester compound (I) of the present invention is incorporated in the organic material, if necessary, there can also be incorporated other additives such as phenol antioxidant, sulfur antioxidant, phosphorous antioxidant, ultraviolet absorber, photostabilizer, peroxide scavenger, polyamide stabilizer, hydroxylamine, lubricant, plasticizer, flame retardant, nucleating agent, metal inactivating agent, antistatic agent, pigment, filler, pigment, anti-blocking agent, surfactant, processing aid, foaming agent, emulsifier, brightener, calcium stearate, neutralizing agent (e.g. hydrotalcite, etc.), coloring modifier (e.g. 9,10-dihydro-oxa-10-phosphophenanthrene-10-oxide, or the like) and co-stabilizer (e.g. benzofuran compounds, indoline compounds, and the like described in U.S. Pat. No. 4,325,853, U.S. Pat. No. 4,338,244, U.S. Pat. No. 5,175,312, U.S. Pat. No. 5,216,053, U.S. Pat. No. 5,252,643 and U.S. Pat. No. 4,316,611, DE-A-4,316,622 and 4,316,876, and EP-A-589,839 and 591,102). These additives can be incorporated together with the phosphorous ester compound (I), or can also be incorporated in the stage other than the stage of incorporating the phosphorous ester compound (I).

Examples of the phenol antioxidant include the followings.

(1) Examples of alkylated monophenol:
2,6-di-t-butyl-4-methylphenol, 2,4,6-tri-t-butylphenol,
2,6-di-t-butyl-4-butylphenol, 2-t-butyl-4,6-dimethylphenol,
2,6-di-t-butyl-4-ethylphenol,
2,6-di-t-butyl-4-n-butylphenol,
2,6-di-t-butyl-4-isobutylphenol,
2,6-dicyclopentyl-4-methylphenol,
2-(α-methylcyclohexyl)-4,6-dimethylphenol,
2,6-dioctadecyl-4-methylphenol, 2,4,6-tricyclohexylphenol,
2,6-di-t-butyl-4-methoxymethylphenol,
2,6-di-nonyl-4-methylphenol,
2,4-dimethyl-6-(1′-methylundecyl-1′-yl)phenol,
2,4-dimethyl-6′-(1′-methylheptadecyl-1′-yl)phenol,
2,4-dimethyl-6- (1′-methyltridecyl-1′-yl)phenol and a mixture thereof.

(2) Examples of alkylthiomethylphenol:
2,4-dioctylthiomethyl-6-t-butylphenol,
2,4-dioctylthiomethyl-6-methylphenol,
2,4-dioctylthiomethyl-6-ethylphenol,
2,6-didodecylthiomethyl-4-nonylphenol and a mixture thereof

(3) Examples of hydroquinone and alkylated hydroquinone:
2,6-di-t-butyl-4-methoxyphenol,
2,5-di-t-butylhydroaquinone, 2,5-di-t-amylhydroquinone,
2,6-diphenyl-4-octadecyloxyphenol,
2,6-di-t-butylhydroquinone,
2,5-di-t-butyl-4-hydroxyanisole,
3,5-di-t-butyl-4-hydroxyphenyl stearate,
bis(3,5-di-t-butyl-4-hydroxyphenyl) adipate and a mixture thereof

(4) Examples of tocopherol:
α-tocopnerol, β-tocopherol, γ-tocopherol, δ-tocopherol and a mixture thereof

(5) Examples of hydroxylated thiodiphenyl ether:
2,2′-thiobis(6-t-butylphenol),
2,2′-thiobis(4-methyl-6-t-butylphenol),
2,2′-thiobis(4-octylphenol),
4,4′-thiobis(3-methyl-6-t-butylphenol),
4,4′-thiobis(2-methyl-6-t-butylphenol),
4,4′-thiobis(3,6-di-t-amylphenol),
4,4′-(2,6-dimethyl-4-hydroxyphenyl) disulfide and the like

(6) Examples of alkylidenebisphenol and derivative thereof:
2,2′-methylenebis(4-methyl-6-t-butylphenol),
2,2′-methylenebis(4-ethyl-6-t-butylphenol),
2,2′-methylenebis[4-methyl-6-(α-methylcyclohexyl)phenol]],
2,2′-methylenebis(4-methyl-6-cyclohexylphenol),
2,2′-methylenebis(4-methyl-6-nonylphenol),
2,2′-methylenebis(4,6-di-t-butylphenol)],
2,2′-ethylidenebis(4,6-di-t-butylphenol),
2,2′-ethylidenebis(4-isobutyl-6-t-butylphenol),
2,2′-methylenebis[6-(α-methylbenzyl)-4-nonylphenol],
2,2′-methylenebis[6-(α,α-dimethylbenzyl)-4-nonylphenol],
4,4′-methylenebis(6-t-butyl-2-methylphenol)4,4′-methylene-bis(2,6-di-t-butylphenol),
4,4′-butylidenebis(3-methyl-6-t-butylphenol),
1,1-bis(4-hydroxyphenyl)cyclohexane,
1,1-bis(5-t-butyl-4-hydroxy-2-methylphenyl)butane,
2,6-bis[3-t-butyl-5-methyl-2-hydroxybenzyl]-4-methylphenol,
1,1,3-tris(5-t-butyl-4-hydroxy-2-methylphenyl)butane,
1,1-bis(5-t-butyl-4-hydroxy-2-methylphenyl)-3-n-dodecyl-mercaptobutane, ethylene glycol
bis[3,3-bis-3′-t-butyl-4′-hydroxyphenyl]butyrate],
bis(3-t-butyl-4-hydroxy-5-methylphenyl)dicyclopentadiene,
bis[2-(3′-t-butyl-2′-hydroxy-5′-methylbenzyl)-6-t-butyl-4-methylphenyl] terephthalate,
1,1-bis(3,5-dimethyl-2-hydroxyphenyl)butane,
2,2-bis(3,5-di-t-butyl-4-hydroxyphenyl)propane,
2,2-bis(5-t-butyl-4-hydroxy-2-methylphenyl)-4-n-dodecyl-mercaptobutane,
1,1,5,5-tetra(5-t-butyl-4-hydroxy-2-methylphenyl)pentane,
2-t-butyl-6-(3′-t-butyl-5′-methyl-2′-hydroxybenzyl)-4-methylphenyl acrylate,
2,4-di-t-pentyl-6-[1-(2-hydroxy-3,5-di-t-pentylphenyl)-ethyl]phenyl acrylate and a mixture thereof.

(7) Examples of O—, N— and S-benzyl derivative:
3,5,3′, 5′-tetra-t-butyl-4,4′-dihydroxydibenzyl ether,
octadodecyl-4-hydroxy-3,5-dimethylbenzylmercapto acetate,
tris(3,5-di-t-butyl-4-hydroxybenzyl)amine,
bis(4-t-butyl-3-hydroxy-2,6-dimethylbenzyl)dithio terephthalate,
bis(3,5-di-t-butyl-4-hydroxybenzyl) sulfide,
isooctyl-3,5-di-t-butyl-4-hydroxybenzylmercapto acetate and a mixture thereof

(8) Examples of hydroxybenzylated malonate derivative:
dioctadecyl-2,2-bis(3,5-di-t-butyl-2-hydroxybenzyl)-malonate,
dioctadecyl-2-(3-t-butyl-4-hydroxy-5-methylbenzyl)malonate,
didodecylmercaptoethyl-2,2-bis(3,5-di-t-butyl-4-hydroxy-benzyl)malonate,
bis[4-(1,1,3,3-tetramethylbutyl)phenyl]-2,2-bis(3,5-di-t-butyl-4-hydroxybenzyl) and a mixture thereof

(9) Examples of aromatic hydroxybenzyl derivative:
1,3,5-trimethyl-2,4,6-tris(3,5-di-t-butyl-4-hydroxybenzyl)benzene,
1,4-bis(3,5-di-t-butyl-4-hydroxybenzyl)-2,3,5,6-tetra-methylbenzene,
2,4,6-tris(3,5-t-butyl-4-hydroxybenzyl)phenol and a mixture thereof

(10) Examples of triazine derivative:
2,4-bis(n-octylthio)-6-(4-hydroxy-3,5-di-t-butylanilino)-1,3,5-triazine,
2-n-octylthio-4,6-bis(4-hydroxy-3,5-di-t-butylanilino)-1,3,5-triazine,
2-n-octylthio-4,6-bis(4-hydroxy-3,5-di-t-butylphenoxy)-1,3,5-triazine,
2,4,6-tris(3,5-di-t-butyl-4-phenoxy)-1,3,5-triazine,
tris(4-t-butyl-3-hydroxy-2,6-dimethylbenzyl isocyanurate,
tris(3,5-di-t-butyl-4-hydroxybenzyl)isocyanurate,
2,4,6-tris(3,5-di-t-butyl-4-hydroxyphenylethyl)-1,3,5-triazine,
2,4,6-tris(3,5-di-t-butyl-4-hydroxyphenylpropyl)-1,3,5-triazine,
tris(3,5-dicyclohexyl-4-hydroxybenzyl)isocyanurate,
tris [2- (3′,5′-di-t-butyl-4′-hydroxycinnamoyloxy)ethyl]isocyanurate and a mixture thereof

(11) Examples of benzyl phosphonate derivative:
dimethyl-3,5-di-t-butyl-4-hydroxybenzyl phosphonate,
diethyl-3,5-di-t-butyl-4-hydroxybenzyl phosphonate,
dioctadecyl-3,5-di-t-butyl-4-hydroxybenzyl phosphonate,
dioctadecyl-5-t-butyl-4-hydroxy-3-methylbenzyl phosphonate,
calcium salt of 3,5-di-t-butyl-4-hydroxybenzyl phosphonic acid monoester and a mixture thereof

(12) Examples of acylaminophenol derivative:
anilide 4-hydroxylaurate, anilide 4-hydroxystearate, octyl-N-(3,5-di-t-butyl-4-hydroxyphenyl)carbamate and a mixture thereof

(13) Ester of β-(3,5-di-t-butyl-4-hydroxyphenyl)propionic acid and the following monohydric or polyhydric alcohol:
methanol, ethanol, octanol, octadecanol, ethylene glycol,
1,3-propanediol, 1,4-butanedlol, 1,6-hexanediol,
1,9-nonanediol, neopentylglycol,
diethyleneglycol, thioethylene glycol, spiroglycol, triethyleneglycol,
pentaerythrltol, tris(hydroxyethyl)isocyanurate,
N,N′-bis(hydroxyethyl)oxamide, 3-thiaundecanol,
3-thiapentadecanol, trimethylhexanediol, trimethylolpropane,
4-hydroxymethyl-1-phospha-2,6,7-trioxabicyclo[2,2,2]octane and a mixture thereof

(14) Ester of β-(5-t-butyl-4-hydroxy-3-methylphenyl) propionic acid and the following monohydric or polyhydric alcohol:
methanol, ethanol, octanol, octadecanol, ethylene glycol,
1,3-propanediol, 1,4-butanediol, 1,6-hexanediol,
1,9-nonanediol, neopentyl glycol, diethylene glycol,
thioethylene glycol, spiro glycol, triethylene glycol,
pentaerythritol, tris(hydroxyethyl)isocyanurate,
N,N′-bis(hydroxyethyl)oxamide, 3-thiaundecanol,
3-thiapentadecanol, trimethylhexanediol, trimethylolpropane,
4-hydroxymethyl-1-phospha-2,6,7-trioxabicyclo[2,2,2]octane and a mixture thereof

(15) Ester of β- (3,5-dicyclohexyl-4-hydroxyphenyl)propionic acid and the following monohydric or polyhydric alcohol:
methanol, ethanol, octanol, octadecanol, ethylene glycol,
1,3-propanediol, 1,4-butanediol, 1,6-hexanediol,
1,9-nonanediol, neopentylglycol, diethyleneglycol,
thioethyleneglycol, spiroglycol, triethyleneglycol,
pentaerythritol, tris(hydroxyethyl)isocyanurate,
N,N′-bis(hydroxyethyl)oxamide, 3-thiaundecanol,
3-thiapentadecanol, trimethylhexanediol, trimethylolpropane,
4-hydroxymethyl-1-phospha-2,6,7-trioxabicyclo[2,2,2]octane and a mixture thereof

(16) Ester of 3,5-t-butyl-4-hydroxyphenylacetic acid and the following monohydric or polyhydric alcohol:
methanol, ethanol, octanol, octadecanol, ethyleneglycol,
1,3-propanediol, 1,4-butanediol, 1,6-hexanediol,
1,9-nonanediol, neopentylglycol, diethyleneglycol,
thioethylene glycol, spiro glycol, triethyleneglycol,
pentaerythritol, tris(hydroxyethyl)isocyanurate,
N,N′-bis(hydroxyethyl)oxamide, 3-thiaundecanol,
3-thiapentadecanol, trimethylhexanediol, trimethylolpropane,
4-hydroxymethyl-1-phospha-2,6,7-trioxabicyclo[2,2,2]octane and a mixture thereof.

(17) Examples of β-(3,5-di-t-butyl-4-hydroxyphenyl)propionic amide:
N,N′-bis[3-(3′,5′-di-t-butyl-4′-hydroxyphenyl)propionyl]-hydrazine,
N,N′-bis[3-(3′,5′-di-t-butyl-4′-hydroxyphenyl propionyl)hexamethylenediamine,
N,N′-bis[3-(3′,5′-di-t-butyl-4′-hydroxyphenyl)propionyl]-trimethylenediamine and a mixture thereof

Examples of the sulfur antioxidant include the followings:
dilauryl 3,3′-thiodipropionate,
tridecyl 3,3′-thiodipropionate,
dimyristyl 3,3′-thiodipropionate,
distearyl 3,3′-thiodipropionate,
lauryl stearyl 3,3′-thiodipropionate and
neopentanetetrayltetrakis(3-lauryl thiopropionate).

Examples of the phosphorous antioxidant include the followings:
triphenyl phosphite, tris(nonylphenyl)phosphite,
tris(2,4-di-t-butylphenyl)phosphite, trilauryl phosphite.
trioctadecyl phosphite, distearyl pentaerythritol diphosphite, diisodecyl pentaerythritol diphosphite,
bis(2,4-di-t-butylphenyl)pentaerythritol diphosphite,
bis(2,4-di-t-butyl-6-methylphenyl)pentaerythritol diphosphite,
bis(2,4-di-t-butyl-6-methylphenyl)pentaerythritol diphosphite,
bis(2,6-di-t-butyl-4-methylphenyl)pentaerythritol diphosphite, bis(2,4,6-tri-t-butylphenyl)pentaerythritol diphosphate, tristearyl sorbitol triphosphite,
tetrakis(2,4-di-t-butylphenyl)-4,4′-diphenylene diphosphonite,
2,2′-methylenebis(4,6-di-t-butylphenyl)2-ethylhexyl phosphite,
2,2′-ethylidenebis(4,6-di-t-butylphenyl) fluoro phosphite,
bis(2,4-di-t-butyl-6-methylphenyl) ethyl phosphite,
bis(2,4-di-t-butyl-6-methylphenyl) methyl phosphite,
2-(2,4,6-tri-t-butylphenyl)-5-ethyl-5-butyl-1,3,2-oxa-phosphorinane,
2,2′,2″-nitrilo[triethyl-tris(3,3′,5,5′-tetra-t-butyl-1,1′-biphenyl-2,2′-diyl)phosphite and a mixture thereof

Examples of the ultraviolet absorber include the followings:

(1) Examples of salicylate derivative:
phenyl salicylate,4-t-butylphenyl salicylate,
2,4-di-t-butylphenyl 3′,5′-di-t-butyl-4′-hydroxybenzoate, 4-t-octylphenyl salicylate,
bis(4-t-butylbenzoyl)resorcinol, benzoylresorcinol,
hexadecyl 3′,5′-di-t-butyl-4′-hydroxybenzoate,
octadecyl 3′,5′-di-t-butyl-4′-hydroxybenzoate,
2-methyl-4,6-di-t-butylphenyl
3′,5′-di-t-butyl-4′-hydroxybenzoate and a mixture thereof

(2) Examples of 2-hydroxybenzophenone derivative:
2,4-dihydroxybenzophenone, 2-hydroxy-4-methoxybenzophenone,
2-hydroxy-4-octoxybenzophenone,
2,2′-dihydroxy-4-methoxybenzophenone,
bis(5-benzoyl-4-hydroxy-2-methoxyphenyl)methane,
2,2′,4,4′-tetrahydroxybenzophenone and a mixture thereof

(3) Examples of 2-(2′-hydroxyphenyl)benzotriazole
2-(2-hydroxy-5-methylphenyl)benzotriazole,
2-(3′,5′-di-t-butyl-2′-hydroxyphenyl)benzotriazole,
2-(5′-t-butyl-2′-hydroxyphenyl)benzotriazole,
2-(2′-hydroxy-5′-octylphenyl)benzotriazole,
2-(3-t-butyl-2-hydroxy-5-methylphenyl)-5-chlorobenzotriazole,
2-(3′-s-butyl-2′-hydroxy-5′-t-butylphenyl)benzotriazole,
2-(2′-hydroxy-4′-octyloxypheny)benzotriazole,
2-(3′,5′-di-t-amyl-2′-hydroxyphenyl)benzotriazole,
2-[2′-hydroxy-3′,5′-bis(β,β-dimethylbenzyl)phenyl]-2H-benz otriazole,
2-[(3′-t-butyl-2′-hydroxyphenyl)-5′-(2-octyloxycarbonylethyl)phenyl]-5-chlorobenzotriazole,
2-[3′-t-butyl-5′-[2-(2-ethylhexyloxy)carbonylethyl]-2′-hydroxyphenyl]-5-chlorobenzotriazole,
2-[3′-t-butyl-2′-hydroxy-5′-(2-methoxycarbonylethyl)phenyl]-5-chlorobenzotriazole,
2-[3′-t-butyl-2′-hydroxy-5′-(2-methoxycarbonylethyl)phenyl]benzotriazole,
2-[3′-t-butyl-2′-hydroxy-5-(2-octyloxycarbonylethyl)phenyl]benzotriazole,
2-[3′-t-butyl-2′-hydroxy-5′-[2-(2-ethylhexyloxy)carbonylethyl]phenyl]benzotriazole,
2-[2-hydroxy-3-(3,4,5,6-tetrahydrophthalimidemethyl)-5-methylphenyl]benzotriazole,
2-(3′,5′-di-t-butyl-2-hydroxyphenyl)-5-chlorobenzotriazole, mixture of
2-(3′-dodecyl-2′-hydroxy-5′-methylphenyl)benzotriazole and
2-[3′-t-butyl-2′-hydroxy-5′-(2-isooctyloxycarbonylethyl)-phenyl]benzotriazole,
2,2′-methylenebis[6-(2H-benzotriazol-2-yl)-4-(1,1,3,3-tetramethylbutyl)phenol,
2,2′-methylenebis[4-t-butyl-6-(2H-benzotriazol-2-yl)phenol], condensate of poly(3-11) (ethylene glycol) and
2-[3′-t-butyl-2′-hydroxy-5′-(2-methoxycarbonylethyl)phenyl]benzotriazole, condensate of poly(3-11) (ethylene glycol) and
methyl 3-[3-(2H-benzotriazol-2-yl-5-t-butyl-4-hydroxyphenyl)propionate,
2-ethylhexyl 3-[3-t-butyl-5-(5-chloro-2H-benzotriazol-2-yl)-4-hydroxyphenyl]propionate,
octyl 3-[3-t-butyl-5-(5-chloro-2H-benzotriazol-2-yl)-4-hydroxyphenyl]propionate,
methyl 3-[3-t-butyl-5-(5-chloro-2H-benzotriazol-2-yl)-4-hydroxyphenyl]propionate,
3-[3-t-butyl-5-(5-chloro-2H-benzotriazol-2-yl)-4-hydroxy-phenylpropionic acid and a mixture thereof.

Examples of the pthotostabilizer include, for example, the followings.

(1) Examples of hindered amine photostabilizer:
bis(2,2,6,6-tetramethyl-4-piperidyl)sebacate,
bis(2,2,6,6-tetramethyl-4-piperidyl)succinate,
bis(1,2,2,6,6-pentamethyl-4-piperidyl)sebacate,
bis(-N-octoxy-2,2,6,6-tetramethyl-4-piperidyl)sebacate,
bis(N-benzyloxy-2,2,6,6-tetramethyl-4-piper4idyl)sebacate,
bis(N-cyclohexyloxy-2,2,6,6-tetramethyl-4-piperidyl)-sebacate,
bis(1,2.2,6,6-pentamethyl-4-piperidyl) 2-(3,5-di-t-butyl-4-hydroxybenzyl)-2-butylmalonate,
bis(1-acrolyl-2,2,6,6-tetramethyl-4-piperidyl) 2,2-bis-(3,5-di-t-butyl-4-hydroxybenzyl)-2-butylmalonate,
bis(1,2,2,6,6-penatmethyl-4-piperidyl decanedioate,
2,2,6,6-tetramethyl-4-piperidyl methacrylate,
4-[3-(3,5-di-t-butyl-4-hydroxyphenyl)propionyloxy]-1-[2-(3-(3,5-di-t-butyl-4-hydroxyphenyl)propionyloxy)ethyl]-2,2,6,6-tetramethylpiperidine,
2-methyl-2-(2,2,6,6-tetramethyl-4-piperidyl)amino-N-(2,2,6,6-tetramethyl-4-piperidyl)propionamide,
tetarkis(2,2,6,6-tetramethyl-4-piperidyl)
1,2,3,4-butaneteracarboxylate,
tetrakis(1,2,2,6,6-pentamethyl-4-piperidyl)
1,2,3,4-butanetetracarboxylate,
mixed ester of 1,2,3,4-butanetetracarboxylic acid and 1,2,2,6,6-pentamethyl-4-piperidinol and 1-tridecanol,
mixed ester of 1,2,3,4-butanetetracarboxylic acid and 2,2,6,6-tetramethyl-4-piperidinol and 1-tridecanol,
mixed ester of 1,2,3,4-butanetetracarboxylic acid and 1,2,2,6,6-pentamethyl-4-piperidinol and
3,9-bis(2-hydroxy-1,1-dimethylethyl)-2,4,8,10-tetraoxaspiro[5.5]undecane
mixed ester of 1,2,3,4-butanetetracarboxylic acid and 2,2,6,6-tetarmethyl-4-piperidinol and
3,9-bis(2-hydroxy-1,1-dimethylethyl)-2,4,8,10-tetraoxaspiro[5,5]undecane,
polycondensate of dimethyl succinate and 1-(2-hydroxyethyl)-4-hydroxy-2,2,6,6-tetramethylpiperidine,
poly[(6-morpholino-1,3,5-triazin-2,4-diyl)((2,2,6,6-tetramethyl-4-piperidyl)imino)hexamethylene ((2,2,6,6-tetramethyl-4-piperidyl)imino],
poly[(6-(l 3,3-tetramethylbutyl)imino-1,3,5-triazin-2,4-diyl((2,2,6,6-tetramethyl-4-piperidyl)imino)-hexamethylene ((2,2,6,6-tetramethyl-4-piperidyl)imino)),
polycondensate of N,N′-bis(2,2,6,6-tetramethyl-4-piperidyl)hexamethylene-diamine and 1,2-bromoethane,
N,N′,4,7-tetrakis[4,6-bis(N-butyl-N-(2,2,6,6-tetramethyl-4-piperidyl)amino)-1,3,5-triazin-2-yl]-4,7-diazadecane-1,10 diamine,
N,N′,4-tris[4,6-bis(N-butyl-N-(2,2,6,6-tetramethyl-4-piperidyl)amino)-1,3,5-triazin-2-yl]-4,7-diazadecane-1,10-diamine,
N,N′,4,7-tetrakis[4,6-bis(N-butyl-N-(1,2,2,6,6-penta-methyl-4-piperidyl)amino)-1,3,5-triazin-2-yl]-4,7-diazadecane-1,10-diamine,
N,N′,4-tris[4,6-bis(N-butyl-N-(1,2,2,6,6-pentamethyl-4-piperidyl)amino)-1,3,5-triazin-2-yl]-4,7-diazadecane-1,10-diamine and a mixture thereof

(2) Examples of acrylate photostabilizer:
ethyl α-cyano-β, β-diphenylacrylate,
isooctyl α-cyano-β, β-diphenylacrylate,
methyl α-carbomethoxycinnamate,
methyl α-cyano-β-methyl-methoxycinnamate,
butyl α-cyano-β-methyl-p-methoxycinnamate,
methyl α-carbomethoxy-p-methoxycinnamate and
N-(β-carbomethoxy-β-cyano-vinyl)-2-methylindoline and a mixture thereof

(3) Examples of nickel photostabilizer: nickel complex of
2,2′-thiobis-[4-(1,1,3,3-tetramethylbutyl)phenol], nickel dibutyldithiocarbamate, nickel salt of monoalkyl ester, nickel complex of ketoxime and a mixture thereof

(4) Examples of oxamide photostabilizer:
4,4′-dioctyloxyoxanilide, 2,2′-diethoxyoxanilide,
2,2′-dioctyloxy-5,5′-di-t-butylanilide,
2,2′-didodecyloxy-5,5′-di-t-butylanilide,
2-ethoxy-2′-ethyloxanilide,
N,N′-bis(3-dimethylaminopropyl)oxamide,
2-ethoxy-5-t-butyl-2′-ethoxyanilide,
2-ethoxy-5,4′-di-t-butyl-2′-ethyloxanilide and a mixture thereof

(5) Examples of 2-(2-hydroxyphenyl)-1,3,5-triazine photostabilzer:
2,4,6-tris(2-hydroxy-4-octyloxyphenyl)-1,3,5-triazine,
2-(2-hydroxy-4-octyloxyphenyl)-4,6-bis(2,4-dimethylphenyl)-1,3,5-triazine,
2-(2,4-dihydroxyphenyl)-4,6-bis(2,4-dimethylphenyl)-1,3,5-triazine,
2,4-bis(2-hydroxy-4-propyloxyphenyl)-6-(2,4-dimethylphenyl)-1,3,5-triazine
2-(2-hydroxy-4-octyloxyphenyl)-4,6-bis-(4-methylphenyl)-1,3,5-triazine,
2-(2-hydroxy-4-dodecyloxyphenyl)-4,6-bis(4-methylphenyl)-1,3,5-triazine,
2-[2-hydroxy-4-(2-hydroxy-3-butyloxypropoxy)phenyl]-4,6-bis(2,4-dimethylphenyl)-1,3,5-triazine,
2-[2-hydroxy-4-(2-hydroxy-3-octyloxyphenyl)-4,6-bis(2,4-dimethylphenyl)-1,3,5-triazine and a mixture thereof.

Examples of the metal inactivating agent include the followings:
N,N′-diphenyloxamide, N-salicylal-N′-salicyloylhydrazine,
N,N′-bis(salicyloyl)hydrazine,
N,N′-bis(3,5-di-t-butyl-4-hydroxyphenylzropionyl)hydrazine, 3-salicyloylamino-1,2,4-triazole,
bis(benzylidene)oxalyl dihydrazide, oxalinide,
isophthaloyl dihydrazide, sebacoylbisphenyl hydrazide,
N,N′-bis(salicyloyl)thiopropionyl dihydrazide and a mixture thereof.

Examples of the peroxide scavenger include ester of β-thiodipropionic acid, mercaptobenzoimidazole, zinc salt of 2-mercaptobenzoimidazole, zinc salt of dibutyldithiocarbamic acid, dioctadecyl disulfide, pentaerythritol tetrakis (β-dodecylmercapto) propionate and a mixture thereof.

Examples of the polyamide stabilizer include iodo-compound, copper or divalent manganese salt of phosphorous compound and a mixture thereof.

Examples of the hydroxyamine include N,N-dibenzylhydroxyamine, N,N-diethylhydroxyamine, N,N-dioctylhydroxyamine, N,N-dilaurylhydroxyamine, N,N-ditetradecylhydroxyamine, N,N-dihexadecylhydroxyamine, N,N-dioctadecylhydroxyamine, N-hexadecyl-N-octadecylhydroxyamine, N-heptadecyl-N-octadecylhydroxyamine and a mixture thereof.

Examples of the neutralizing agent include calcium stearate, zinc stearate, magnesium stearate, hydrotalcite (basic magnesium aluminum hydroxycarbonate hydrate), melamine, amine, polyamide, polyurethane and a mixture thereof.

Examples of the lubricant include aliphatic hydrocarbon (e.g. paraffin, wax, etc.), higher aliphatic acid having 8 to 22 carbon atoms, higher aliphatic acid (having 8 to 22 carbon atoms) metal (Al, Ca, Mg, Zn) salt, aliphatic alcohol having 8 to 22 carbon atoms, polyglycol, ester of higher fatty acid having 4 to 22 carbon atoms and aliphatic monohydric alcohol having 4 to 18 carbon atoms, higher aliphatic amide having 8 to 22 carbon atoms, silicone oil, rosin derivative and the like.

Examples of the nucleating agent include the followings:
sodium 2,2′-methylenebis(4,6-di-t-butylphenyl)phosphate,
[phosphoric acid-2,2′-methylenebis(4,6-di-t-butyl-phenyl)]dihydroxyaluminum,
bis[phosphoric acid-2,2′-methylenebis(4,6-di-t-butyl-phenyl)]dihydroxyaluminum,
tris[phosphoric acid-2,2′-methylenebis(4,6-di-t-butylphenyl)]aluminum,
sodium bis(4,6-di-t-butylphenyl)phosphate,
benzoic acid metal salt such as sodium benzoate,
aluminum p-t-butylbenzoate,
1,3:2,4-bis(O-benzylidene)sorbitol,
1,3:2,4-bis(O-ethylbenzylidene)sorbitol,
1,3:2,4-bis(O-methylbenzylidene)sorbitol,
1,3-O-3,4-dimethylbenzylidene-2,4-O-benzylidenesorbitol,
1,3-O-benzylidene-2,4-O-3,4-dimethylbenzylidene sorbitol,
1,3:2,4-bis(O-3,4-dimethylbenzylidene)sorbitol,
1,3-O-p-chlorobenzylidene-2,4-O-3,4-dimethylbenzylidene sorbitol,
1,3-O-3,4-dimethylbenzylidene-2,4-O-p-chlorobenzylidene sorbitol, 1,3:2,4-bis(O-p-chlorobenzylidene)sorbitol and a mixture thereof.

Examples of the filler include calcium carbonate, silicate, glass fiber, asbestos, talc, kaoline, mica, barium sulfate, carbon black, carbon fiber, zeolite and a mixture thereof.

Among these additives above, phenol antioxidant, phosphorous antioxidant, ultraviolet absorber, hindered amine photostabilizer, peroxide scaveneger and neutralizing agent are preferably used.

Examples of the particularly preferred phenol antioxidant include the following compounds, and they may be used in combination of the two or more:
2,6-di-t-butyl-4-methylphenol, 2,4,6-tri-t-butylphenol,
2,4-dioctylthiomethyl-6-methylphenol,
2,2′-thiobis(6-t-butylphenol),
4,4′-thiobis(3-methyl-6-t-butylphenol),
2,2′-methylenebis(4-methyl-6-t-butylphenol),
2,2′-methylenebis[4-ethyl-6-t-butylphenol],
2,2′-methylenebis(4-ethyl-6-(α-methylcyclohexyl)phenol),
2,2′-methylenebis(4-methyl-6-cyclohexylphenol),
2,2′-methylenebis(4,6-di-t-butylphenol),
2,2′-ethylidenebis(4,6-di-t-butylphenol),
4,4′-methylenebis(6-t-butyl-2-methylphenol),
4,4′-methylenebis(2,6-di-t-butylphenol),
4,4′-butylidenebis(3-methyl-6-t-butylphenol),
1,1′-bis(4-hydroxyphenyl)cyclohexane,
1,1-bis(5-t-butyl-4-hydroxy-2-methylphenyl)butane,
1,1,3-tris(5-t-butyl-4-hydroxy-2-methylphenyl)butane, ethylene glycol bis[3,3-bis-3′-t-butyl-4′-hydroxyphenyl]-butyrate],
2-t-butyl-6-(3′-t-butyl-5′-methyl-2′-hydroxybenzyl)-4-methyylphenyl acrylate,
2,4-di-t-pentyl-6-[1-(2-hydroxy-3,5-di-t-pentylphenyl)ethyl]phenyl acrylate,
2,4,6-tris(3,5-di-t-butyl-4-phneoxy)-1,3,5-triazine,
tris(4-t-butyl-3-hydroxy-2,6-dimethylbenzyl)isocyanurate,
bis(3,5-di-t-butyl-4-hydroxybenzyl)isocyanurate,
tris[2-(3′,5′-di-t-butyl-4′-hydroxycinnamoyloxy)ethyl]-isocyanurate,
diethyl-3,5-di-t-butyl-4-hydroxybenzyl phosphonate,
di-n-octadecyl-3,5-di-t-butyl-4-hydroxybenzyl phosphonate,
calcium salt of 3,5-di-t-butyl-4-hydroxybenzylphosphonic acid monoester,
n-octadecyl 3-(3,5-di-t-butyl-4-hydroxyphenyl)propionate,
neopentanetetrayltetrakis(3,5-di-t-butyl-4-hydroxy-cinnamate),
thiodiethylenebis(3,5-di-t-butyl-4-hydroxycinnamate),
1,3,5-trimethyl-2,4,6-tris(3,5-di-t-butyl-4-hydroxy-benzyl)benzene,
3,6-dioxaoctamethylenebis(3,5-di-t-butyl-4-hydroxycinnamate),
hexamethylenebis(3,5-di-t-butyl-4-hydroxycinnamate),
triethylene glycol bis(5-t-butyll-4-hydroxy-3-methylcinnamate),
3,9-bis[2-(3-(3-t-butyl-4-hydroxy-5-methylphenyl)-propionyloxy)-1,1-di-methylethyl]-2,4,8,10-tetraoxaspiro-[5.5]undecane,
N,N′-bis[3-(3′,5′-di-t-butyl-4′-hydroxyphenyl)propionyl]-hydrazine and
N,N′-bis[3-(3′,5′-di-t-butyl-4′-hydroxyphenyl)propionyl]-hexamethylenediamine.

Examples of the particularly preferred phosphorous antioxidant include the followings, and they may be used in combination of the two or more:
tris(nonylphenyl)phosphite,
tris(2,4-di-t-butylphenyl)phosphite,
distearyl pentaerythritol diphosphite,
bis(2,4-di-t-butylphenyl)pentaerythritol diphosphite,
bis(2,4-di-t-butyl-6-methylphenyl)pentaerythritol diphosphite,
bis(2,6-di-t-butyl-4-methylphenyl)pentaerythritol diphosphite,
tetrakis (2,4-di-t-butylphenyl)-4,4′-diphenylenediphosphonite,
2,2′-methylenebis(4,6-di-t-butylphenyl)2-ethylhexyl phosphite,
2,2′-ethylidenebis(4,6-di-t-butylphenyl)fluoro phosphite,
bis(2,4-di-t-butyl-6-methylphenyl)ethyl phosphite,
2-(2,4,6-tri-t-butylphenyl)-5-ethyl-5-butyl-1,3,2-oxaphosphorinane and
2,2′,2″-nitrilo[triethyl tris(3,3′,5,5′-tetra-t-butyl-1,1′-biphenyl-2,2′-diyl)phosphite.

Examples of the particularly preferred ultraviolet absorber include the followings, and two or more kinds of them can be used, which are:
phenyl salicylate, 4-t-butylphenyl salicylate,
2,4-di-t-butylphenyl 3′,5′-di-t-butyl-4′-hydroxybenzoate,
4-t-octylphenyl salycilate, 2,4-dihydroxybenzophenone,
2-hydroxy-4-methoxybenzophenone,
2-hydroxy-4-octoxybenzophenone,
2,2′-dihydroxy-4-methoxybenzophenone,
bis(5-benzoyl-4-hydroxy-2-methoxyphenyl)methane,
2,2′4,4′-tetrahydroxybenzophenone,
2-(2-hydroxy-5-methylphenyl)benzotriazole,
2-(3′,5′-di-t-butyl-2′-hydroxyphenyl)benzotriazole,
2-(5′-t-butyl-2′-hydroxyphenyl)benzotriazole,
2-(2′-hydroxy-5′-t-octylphenyl)benzotriazole,
2-(3-t-butyl-2-hydroxy-5-methylphenyl)-5-chlorobenzotriazole,
2-(3′-s-butyl-2′-hydroxy-5′-t-butylphenyl)benzotriazole,
2-(2′-hydroxy-4′-octyloxyphenyl)benzotriazole,
2-(3′,5′-di-t-amyl-2′-hydroxyphenyl)benzotriazole
and2-[2′-hydroxy-3′,5′-bis(α,α-dimethylbenzyl)phenyl]-2H-benzotriazole.

Examples of the particularly preferred photostabilizer include the followings, and two or more kinds of them can be used, which are:
bis(2,2,6,6-tetramethyl-4-piperidyl)sebacate,
bis(1,2,2,6,6-pentamethyl-4-piperidyl)sebacate,
bis(N-octoxy-2,2,6,6-pentamethyl-4-piperidyl)sebacate,
bis(N-octoxy-2,2,6,6-pentamethyl-4-piperi-dyl)sebacate,
bis(N-benzyloxy-2,2,6,6-tetarmethyl-4-piperidyl)sebacate,
bis(N-cyclohexyloxy-2,2,6,6-tetramethyl-4-piperidyl)sebacate,
bis(1,2,2,6,6-pentamethyl-4-piperidyl) 2-(3,5-di-t-butyl-4-hydroxybenzyl)-2-butylmalonate,
bis(1-acryloyl-2,2,6,6-tetramethyl-4-piperidyl) 2,2-bis-(3,5-di-t-butyl-4-hydroxybenzyl)-2-butylmalonate,
bls(2,2,6,6-tetramethyl-4-piperidyl)succinate,
2,2,6,6-tetramethyl-4-piperidyl methacrylate,
4-[3-(3,5-di-t-butyl-4-hydroxyphenyl)propionyloxy]-1-[2-(3-(3,5-di-t-butyl-4-hydroxyphenyl)propionyloxy)ethyl]-2,2,6,6-tetramethylpiperidine,
2-methyl-2-(2,2,6,6-tetramethyl-4-piperidyl)amino-N-(2,2,6,6-tetarmethyl-4-piperidyl)propionamide,
tetrakis(2,2,6,6-tetramethyl-4-piperidyl)
1,2,3,4-butanetetracarboxylate.
tetrakis(1,2,6,6-pentamethyl-4-piperidyl)
1,2,3,4-butanetetracarboxylate,
mixed ester of 1,2,3,4-butanetetracarboxylic acid and 1,2,2,6,6-pentamethyl-4-piperidinol and 1-tridecanol,
mixed ester of 1,2,3,4-butanetetracarboxylic acid and 2,2,6,6-tetramethyl-4-pioeridinol and 1-tridecanol,
mixed ester of 1,2,3,4-tetracarboxylic acid and 1,2,2,6,6-pentamethyl-4-piperidinol and
3,9-bis(2-hydroxy-1,1-dimethylethyl)-2,4,8,10-tetraoxaspiro[5.5]undecane,
mixed ester of 1,2,3,4-butanetetracarboxylic acid and 2,2,6,6-tetarmethyl-4-piperidinol and
3,9-bis(2-hydroxy-l,1-dimethylethyyl)-2,4,8,10-tetraoxaspiro[5.5]undecane,
polycondensate of dimethyl succinate and
1-(2-hydroxyethyl)-4-hydroxy-2,2,6,6-tetramethylpiperidine,
poly[(6-morpholino-1,3,5-triazin-2,4-diyl)((2,2,6,6-tetra-methyl-4-piperidyl)imino)hexamethylene ((2,2,6,6-tetramethyl-4-piperidyl)imino)] and
poly[(6-(1,1,3,3-tetramethylbutyl)-1,3,5-triazin-2,4-diyl-((2,2,6,6-tetramethyl-4-piperidyl)imino)hexamethylene-((2,2,6,6-tetra.methyl-4-pioperidyl)imino)).

To incorporate the phosphorous ester compound (I) or the optionally used other additives into the organic material, all the known methods and devices for obtaining a homogeneous mixture can be used.

For example, when the organic material is a solid polymer, the phosphorous ester compound (I) and other additives can be directly dry-blended with the solid polymer, or the phosphorous ester compound (I) and other additives can also be incorporated into the solid polymer in the form of a master-batch.

When the organic material is a liquid polymer, the phosphorous ester compound (I) and other additives can be incorporated into the polymer solution during or immediately after polymerization in the form of a solution or a dispersion thereof.

On the other hand, when the organic material is a liquid such as oil, the phosphorous ester compound (I) and other additives can also be dissolved by directly adding, or the phosphorous ester compound (I) and other additives can also be added in the form of a solution or dispersion in a liquid medium.

### EXAMPLES

The present invention will be illustrated by the following Examples, but are not to be construed to limit the invention thereto.

### Example 1

### Production of bis[4-[[2,4,8,10-tetrakis(1,1-dimethylethyl)dibenz[d,f][1,3,2]dioxaphosphepin-6-yl]oxy]phenyl] sulfide, Compound 1

To a flask equipped with a thermometer, agitator and cooling tube were charged 10.0 g of 3,3′,5,5′-tetra-t-butylbiphenyl-2,2′-diol and 110 ml of toluene under nitrogen atmosphere, and then 3.5 g of phosphorous trichloride, and 6.4 g of triethylamine were added thereto under stirring and kept at 80° C. for 2 hrs. After cooled to room temperature, 2.7 g of bis(4-hydroxydiphenyl)sulfide were added thereto and then 3.8 g of triethylamine were added thereto and kept at 80° C. for 2 hrs. After cooled to room temperature, the resulting triethylamine hydrochloride was filtered off, and washed. Obtained filtrate was concentrated and then purified by silicic acid column chromatography to give 10.1 g of white crystals.

Mass Spectrum analysis (FD-MS): m/z=1094

### Example 2

### Production of bis[(4-[[2,4,8,10-tetrakis(1,1-dimethylethyl)dibenz[d,f][1,3,2]dioxaphosphepin-6-yl]oxy]phenyl] ether, Compound 2

7.3 g white crystals were obtained in a similar manner as in Example 1 except that 2.5 g of 4, 4′-dihydroxyphenyl ether were employed instead of bis(4-hydroxydiphenyl) sulfide.

Mass spectrum analysis (FD-MS): m/z=1079

### Example 3

### Production of bis[4-[(2,4,8,10-tetrakis(1,1-dimethylethyl)dibenz[d,f][1,3,2]dioxaphosphepin-6-yl]oxy]phenyl] sulfone, Compound 3

7.0 g of white crystals were obtained in a similar manner as in Example 1 except that 4.7 g of bis(4-hydroxyphenyl) sulfone were employed in place of bis(4-hydroxydiphenyl) sulfide.

Mass spectrum analysis(FD-MS): m/z=1126

### Example 4

### Coloring Test of Polycarbonate

Composition

Polycarbonate 100 parts

Employed stabilizer 0.05 part

Compound 1(produced in Example 1)

Compound 2(produced in Example 2)

Compound 3(produced in Example 3)

P-1: Mixture of 3-(3,4-dimethylphenyl)-5,7-di-t-butyl-3H-benzofuran-2-on, n-octadecyl 3-(3,5-di-t-butyl-4-hydroxyphenyl)propionate, and tris(2,4-di-t-butylphenyl) phosphite in a weight ratio of 15:42.5:42.5.

The compositions above were melt-kneaded using a 30 mm φ mono-axis extruder at 340° C. to produce pellets. YI (yellowness index) of the obtained pellets were measured by a color-difference meter, and the results are summarized in Table 1 below. The lower the YI value is, the more excellent in anti-coloring properties.

TABLE 1

| | | | | Comparative | Comparative |
|---|---|---|---|---|---|
| | Ex. 1 | Ex. 2 | Ex. 3 | Example 1 | Example 2 |
| Test | Compound 1 | Compound 2 | Compound 3 | — | P-1 |
| Compound | | | | | |
| Yellowness | 0.2 | 0.1 | 0.6 | 1.8 | 1.0 |
| YI | | | | | |

### INDUSTRIAL APPLICABILITY

The phosphorous ester (I) of the present invention has excellent properties as a stabilizer for various organic materials including thermoplastic resins such as polyolefnes, engineering plastics or the like, and organic materials containing the compound is protected from coloring during the production, processing or use thereof.

1. A phosphorous ester compound of formula (I): 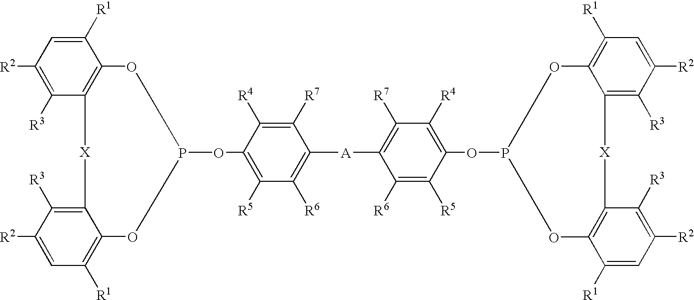
wherein R¹ and R² independently represent hydrogen, C₁₋₈ alkyl, C₅₋₈ cycloalkyl, C₆₋₁₂ alkylcycloalkyl, C₇₋₁₂ aralkyl or phenyl,
R³ represents hydrogen or C₁₋₈ alkyl,
R⁴, R⁵, R⁶ and R⁷ independently represent hydrogen, C₁₋₈ alkyl, C₅₋₈ cycloalkyl, C₆₋₁₂ alkylcycloalkyl, C₇₋₁₂ aralkyl, phenyl, C₁₋₈ alkoxy, or halogen,
provided that four R¹ groups are the same or different, four R² groups are the same or different, two R⁴ groups are the same or different, two R⁵ groups are the same or different, two R⁶ groups are the same or different, and two R⁷ groups are the same or different,
X represents a single bond, sulfur, or —CHR⁸—, wherein R⁸ represents hydrogen, C₁₋₈ alkyl, or C₅₋₈ cycloalkyl,
A represents
a single bond, oxygen, sulfur, sulfonyl, sulfinyl, carbonyl group, phenylene, a group of formula (IV):
—C(R⁹)(R¹⁰)— (IV)
wherein R⁹ and R¹⁰ independently represent hydrogen, phenyl, C₁₋₈ alkyl, C₅₋₈ cycloalkyl, or C₅₋₈ alkylcycloalkyl,
a divalent bicyclic saturated hydrocarbon group, or
a divalent hydrocarbon group of formula (V): 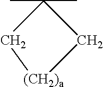
wherein a represents an integer of 2 to 5, the alkylene group may be substituted with C₁₋₈ alkyl group, or may form a fused ring with one or two benzene rings.

2. A phosphorous ester compound according to claim 1, wherein
R¹ repersents a tertiary alkyl or substituted or unsubstituted cyclohexyl,
R² represents C₁₋₅ alkyl,
R³ represents hydrogen, C₁₋₅ alkyl,
R⁴, R⁵, R⁶ and R⁷ each represents hydrogen, or C1- alkyl,
X represents a single bond, methylene, or methylene substituted with C₁₋₄ alkyl,
A represents a single bond, oxygen, sulfur, sulfonyl, sulfinyl, carbonyl, phenylene, or isopropylidene.

3. A process for producing the phosphorous ester as defined in claim 1, which comprises reacting a diphenol compound of formula (II): 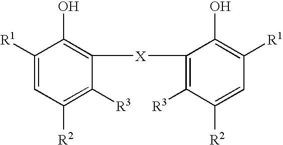
wherein R¹, R², R³ and X are as defined in claim 1,
phosphorous trichloride, and a bisphenol compound of formula (III): 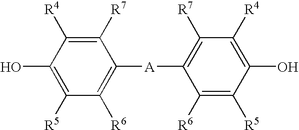
wherein R⁴, R⁵, R⁶, R⁷ and A are as defined in claim 1.

4. A production process according to claim 3, wherein the diphenol compound of formula (2) is reacted with phosphorous tricloride, and then reacting the resulting compound with the bisphenol compound of formula (III).

5. A stabilizer for organic material comprising the phosphorous ester compound as defined in claim 1.

6. A stabilizer according to claim 5, which further comprises at least one ingredient selected from the group consisiting of an amine compound and a metal salt that binds with an acid.

7. A stabilizer according to claim 6, wherein the metal compound that binds with an acid is hydrohalcite.

8. A stabilizer according to claim 6, wherein the amine compound is dialkanolamine, monoalkanolamine, aromatic amine, alkylamine, polyalkyleneamine, or hinderedamine type stabilizer.

9. A method for stabilizing an organic material, which comprises compounding the phosphorous ester compound defined in claim 1 with an organic material.

10. A method for stabilizing according to claim 9, wherein the organic material is thermoplastic resin.

11. A method for stabilizing according to claim 10, wherein the thermoplastic resin is polyolefin or engineering plastic.

12. A stabilized organic material composition, which comprises an organic material and the phosphorous ester defined in claim 1.

13. A composition according to claim 12, wherein the organic material is thermoplastic resin.

14. A composition according to claim 13, wherein the thermoplastic resin is polyolefin or engineering plastic.
